(19) United States
(12) Patent Application Publication
(10) Pub. No.: US 2012/0264093 A1
(43) Pub. Date: Oct. 18, 2012

(54) Product Educational Tool

(76) Inventors: Robert Eric MacDonald, Kohler, WI (US); Marcille Faye Ruman, Oshkosh, WI (US)

(21) Appl. No.: 13/087,411

(22) Filed: Apr. 15, 2011

(51) Int. Cl. G09B 19/00

(52) U.S. Cl. 434/236

(57) ABSTRACT

A disposable absorbent article system includes a disposable absorbent article having a liner, an article absorbent core, and an article reactive mechanism configured to produce a result upon exposure to an insult; and an article simulator having a substrate and a simulator reactive mechanism configured to produce the result upon exposure to a simulant, the article simulator having fewer components than the absorbent article. A method for facilitating training includes providing an article simulator having a substrate and a simulator reactive mechanism configured to produce a simulator result upon exposure to a simulant, wherein the simulator result simulates an article result obtained from an insult to a disposable absorbent article having an article reactive mechanism, and wherein the article simulator has fewer components than the absorbent article.

### BACKGROUND

Caregivers often have high hopes for training aids, and expect dramatic reactions from their child and from potty training efforts. For example, when using training pants, caregivers have high hopes for toilet training success. Caregivers can become frustrated when their children do not exhibit a dramatic change in behavior (e.g., wetness awareness) or make rapid progress in toilet training (e.g., stops wetting, uses the toilet). As a further complication, a caregiver has much higher expectations when using a tactile or cooling awareness product than with standard training pants.

Studies have shown that caregivers do not introduce sensing/indicating products to their children or other subjects, and most children and other subjects are not certain what to expect or how to react when they insult the product. Caregivers believe the child is too young to understand the concept—yet somehow expect a dramatic negative experience to make the connection and alter behavior. Fewer than half tell their children that the cool feeling occurs after wetting or demonstrate the pant becoming cool. This lack of clear association of coolness and wetness by the child highlights the need for an educational demonstration.

Similarly, disposable absorbent articles can include other sensors and/or indicators that can be used to provide an indication of wetness, fullness, a health condition, or any other suitable condition. The subject matter of the present disclosure can be used in a similar manner in conjunction with any such type of disposable absorbent article.

### SUMMARY

The present disclosure is generally directed to educational tools for use in conjunction with disposable absorbent articles, particularly those that can help to educate a caregiver and a user/subject with respect to the sensor/indicator such as an absorbent article might contain. To enhance the training experience, caregivers are encouraged to introduce the sensor/indicator product to their children or other subjects by demonstrating the sensor/indicator article including a demonstration of the expected result. A simulation tool and instructions can be included with a package of training pants so caregivers and children or other subjects can see and feel how the product works.

The present disclosure provides a disposable absorbent article system including a disposable absorbent article having a liner, a liquid-impermeable outer cover, an article absorbent core, and an article reactive mechanism configured to produce a result upon exposure to an insult; and an article simulator having a substrate and a simulator reactive mechanism configured to produce the result upon exposure to a simulant, the article simulator having fewer components than the absorbent article.

The present disclosure also provides a method for facilitating training including providing a disposable absorbent article having an article absorbent core and an article reactive mechanism configured to produce a result upon exposure to an insult; providing an article simulator having a substrate and a simulator reactive mechanism configured to produce the result upon exposure to a simulant; and instructing a consumer to use the simulator to produce the result.

The present disclosure also provides a method for facilitating training including providing an article simulator having a substrate and a simulator reactive mechanism configured to produce a simulator result upon exposure to a simulant, wherein the simulator result simulates an article result obtained from an insult to a disposable absorbent article having an article reactive mechanism, and wherein the article simulator has fewer components than the absorbent article.

An easy-to-use simulation tool and package inserts offering suggestions for introduction can help to counteract lack of behavior change due to the child or other subject not understanding the meaning of the result.

### BRIEF DESCRIPTION OF THE DRAWINGS

The foregoing and other features and aspects of the present invention and the manner of attaining them will become more apparent, and the invention itself will be better understood by reference to the following description, appended claims and accompanying drawings, where:

FIG. 1 is a perspective view of an example of a disposable absorbent article to be used in conjunction with a simulation tool of the present application;

FIG. 2 is a perspective view of an example of a disposable simulator to be used in conjunction with the disposable absorbent article of FIG. 1; and

FIG. 3 is a graphic representation of the use of the disposable absorbent article and simulator of FIGS. 1 and 2.

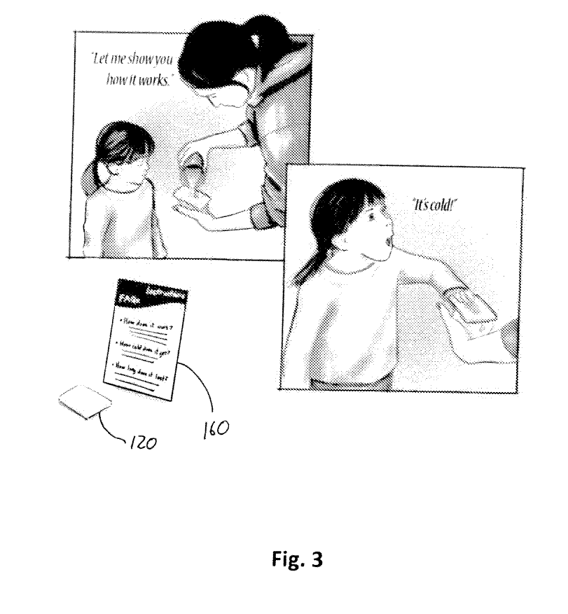

Repeat use of reference characters in the present specification and drawings is intended to represent the same or analogous features or elements of the present invention. The drawings are representational and are not necessarily drawn to scale. Certain proportions thereof may be exaggerated, while others may be minimized.

### DETAILED DESCRIPTION

It is to be understood by one of ordinary skill in the art that the present discussion is a description of exemplary aspects of the present invention only, and is not intended as limiting the broader aspects of the present invention.

The present disclosure is generally directed to educational tools for use in conjunction with disposable absorbent articles, particularly those that can help to educate a caregiver and a user/subject with respect to the sensor/indicator such as an absorbent article might contain. The present disclosure describes an instruction card and a simulation tool that is provided in conjunction with a package of absorbent articles so caregivers and children or other subjects can see and feel how the product works.

Similarly, disposable absorbent articles can include other sensors and/or indicators that can be used to provide an indication of wetness, fullness, a health condition, or any other suitable condition. The subject matter of the present disclosure can be used in a similar manner in conjunction with any such type of disposable absorbent article.

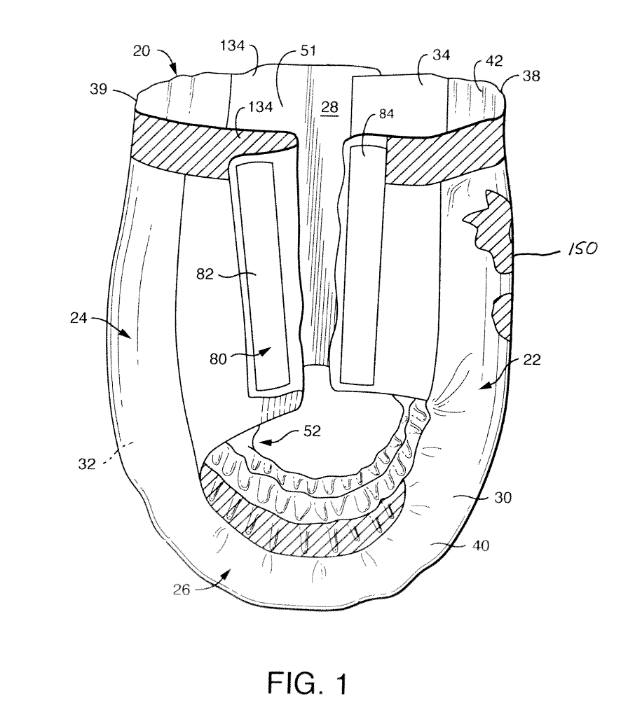

The methods and apparatus of the present disclosure can be used in association with a variety of disposable absorbent articles including diapers, training pants, feminine hygiene products, incontinence products, medical garments, other personal care or health care garments, swim pants, athletic clothing, pants and shorts, wipes, potty targets, mats, facial tissue, nonwoven toweling, and the like. An insult to a disposable absorbent article includes urination, defection, menstruation, and any other deposition of a body exudate on or in a disposable absorbent article. For ease of explanation, the methods and apparatus of the present disclosure are hereafter described in connection with making pre-fastened training pants, generally indicated as 20 in FIG. 1. In particular, the methods and apparatus will be described in terms of those for making pre-fastened disposable pants as described in U.S. patent application Ser. No. 09/444,083 titled “Absorbent Articles With Refastenable Side Seams” and filed Nov. 22, 1999 (corresponding to PCT application WO 00/37009 published Jun. 29, 2000) by A. L. Fletcher et al., the disclosure of which is incorporated herein by reference. Article 20 can also be constructed using the methods and apparatus disclosed in U.S. Pat. NO. 4,940,464 issued Jul. 10, 1990 to Van Gompel et al.; and U.S. Pat. No. 5,766,389 issued Jun. 16, 1998 to Brandon et al.; the disclosures of which are also incorporated herein by reference.

Referring now to FIG. 1, in one aspect, the absorbent article is a disposable article 20 including a garment-facing liquid-impermeable backsheet or outer cover 40, a body-facing liquid-permeable layer, topsheet, or bodyside liner 42 positioned in facing relation with the outer cover 40, and an absorbent body 32, such as an absorbent pad, that is located between the bodyside liner 42 and the outer cover 40. The article 20 has an outer surface 30, an inner surface 28, a front waist region 22, a back waist region 24, and a crotch region 26 connecting the front and back waist regions 22, 24. The article 20 also includes a front waist edge 38 and a back waist edge 39. The outer cover 40 defines a length and a width that, in the illustrated aspect, coincide with the length and width of the article 20. The absorbent body 32 generally defines a length and width that are less than the length and width of the outer cover 40, respectively. Thus, marginal portions of the article 20, such as marginal sections of the outer cover 40, can extend past the terminal edges of the absorbent body 32. In the illustrated aspects, for example, the outer cover 40 extends outwardly beyond the terminal marginal edges of the absorbent body 32 to form side margins and end margins of the article 20. The bodyside liner 42 is generally coextensive with the outer cover 40 but can optionally cover an area that is larger or smaller than the area of the outer cover 40, as desired. In other words, the bodyside liner 42 is connected in superposed relation to the outer cover 40. The outer cover 40 and bodyside liner 42 are intended to face the garment and body of the wearer, respectively, while in use.

To provide improved fit and to help reduce leakage of body exudates from the article 20, the article side margins and end margins can be elasticized with suitable elastic members, such as single or multiple strands of elastic. The elastic strands can be composed of natural or synthetic rubber and can optionally be heat shrinkable or heat elasticizable. For example, the article 20 can include leg elastics that are constructed to operably gather and shirr the side margins of the article 20 to provide elasticized leg bands that can closely fit around the legs of the wearer to reduce leakage and provide improved comfort and appearance. Similarly, waist elastics can be employed to elasticize the end margins of the article 20 to provide elasticized waists. The waist elastics are configured to operably gather and shirr the waist sections to provide a resilient comfortably close fit around the waist of the wearer.

The article 20 includes leg openings 52 and a waist opening 51.

Fastening means, such as hook and loop fasteners 80, can be employed to secure the article 20 on a wearer. Alternatively, other fastening means, such as buttons, pins, snaps, adhesive tape fasteners, cohesives, mushroom-and-loop fasteners, a belt, and so forth, as well as combinations including at least one of the foregoing fasteners can be employed. Additionally, more than two fasteners can be provided, particularly if the article 20 is to be provided in a prefastened configuration.

The article 20 can further include any other suitable layers between the absorbent body 32 and the bodyside liner 42 or outer cover 40. For example, the article 20 can include a ventilation layer located between the absorbent body 32 and the outer cover 40 to insulate the outer cover 40 from the absorbent body 32, to improve air circulation, and to effectively reduce the dampness of the garment-facing surface of the outer cover 40. The ventilation layer can also assist in distributing fluid exudates to portions of the absorbent body 32 that do not directly receive the insult. The article 20 can also include a surge management layer located between the bodyside liner 42 and the absorbent body 32 to prevent pooling of the fluid exudates and further improve air exchange and distribution of the fluid exudates within the article 20.

Other suitable article components that can be incorporated on absorbent articles include containment flaps, waist flaps, elastomeric side panels, and the like. Examples of possible article configurations are described in U.S. Pat. No. 4,798,603 issued Jan. 17, 1989, to Meyer et al.; U.S. Pat. No. 5,176,668 issued Jan. 5, 1993, to Bernardin; U.S. Pat. No. 5,192,606 issued Mar. 9, 1993, to Proxmire et al., and U.S. Pat. No. 5,509,915 issued Apr. 23, 1996 to Hanson et al.

The bodyside liner 42, employed to help isolate the wearer's skin from liquids held in the absorbent body 32, can define a compliant, soft, non-irritating feel to the wearer's skin. Further, the bodyside liner 42 can be less hydrophilic than the absorbent body 32, to present a relatively dry surface to the wearer, and can be sufficiently porous to be liquid permeable, permitting liquid to readily penetrate through its thickness. A suitable bodyside liner 42 can be manufactured from a wide selection of web materials, such as porous foams, reticulated foams, apertured plastic films, natural fibers (for example, wood or cotton fibers), synthetic fibers (for example, polyester or polypropylene fibers), and the like, as well as a combination of materials including at least one of the foregoing materials.

The absorbent body 32 of the article 20 can include a matrix of hydrophilic fibers, such as a fibrous web of cellulosic fibers, mixed with particles of a high-absorbency material (such as the material commonly known as superabsorbent material). The wood pulp fluff can be exchanged with synthetic, polymeric, meltblown fibers, and the like, as well as a combination including at least one of the foregoing. The superabsorbent particles can be substantially homogeneously mixed with the hydrophilic fibers or can be nonuniformly mixed. Alternatively, the absorbent body 32 can include a laminate of fibrous webs and superabsorbent material and/or a suitable matrix for maintaining the superabsorbent material in a localized area.

The absorbent body 32 can include a fibrous web (e.g., including cellulosic fibers) and a superabsorbent material. When the absorbent body 32 includes a combination of hydrophilic fibers and high-absorbency particles, the hydrophilic fibers and high-absorbency particles can form an average basis weight for the absorbent body 32 that can be about 400 grams per square meter (g/m²) to about 900 g/m², or, more specifically, about 500 g/m² to about 800 g/m², and even more specifically, about 550 g/m²to about 750 g/m².

The high-absorbency material (e.g., superabsorbent) can be natural, synthetic, and modified natural polymers and materials; inorganic materials (such as silica gels); organic compounds (such as crosslinked polymers); and the like, as well as combinations including at least one of the foregoing. The term “crosslinked” refers to methods for effectively rendering normally water-soluble materials substantially water insoluble but swellable. Such methods include, but are not limited to, physical entanglement, crystalline domains, covalent bonds, ionic complexes and associations, hydrophilic associations such as hydrogen bonding, and/or hydrophobic associations or Van der Waals forces. Examples of high-absorbency materials include, but are not limited to, the alkali metal and ammonium salts of poly(acrylic acid) and poly(methacrylic acid), poly(acrylamides), poly(vinyl ethers), maleic anhydride copolymers with vinyl ethers and alpha-olefins, poly(vinyl pyrrolidone), poly(vinyl morpholinone), poly(vinyl alcohol), and the like, as well as copolymers and combinations including at least one of the foregoing. Further polymers suitable for use in the absorbent body 32 include, but are not limited to, polymers (natural and modified natural), such as hydrolyzed acrylonitrile-grafted starch, acrylic acid grafted starch, methyl cellulose, carboxymethyl cellulose, hydroxypropyl cellulose, and the natural gums, such as alginates, xanthan gum, locust bean gum, and so forth. Mixtures of natural and wholly or partially synthetic absorbent polymers can also be useful. Similarly useful are various copolymers and, combinations including at least one of any of the above high-absorbency materials. An example of high-absorbency material is DRYTECH 2035 polymer available from Dow Chemical, a business having offices in Midland, Mich. Other suitable superabsorbents can include FAVOR SXM 880 polymer obtained from Stockhausen, a business having offices in Greensboro, N.C.

The high absorbency material can be in any of a wide variety of geometric forms. Generally, it is preferred that the high absorbency material be in the form of discrete particles. However, the high absorbency material can also be in the form of fibers, flakes, rods, spheres, needles, particles, or the like, as well as combinations including at least one of the foregoing. In general, the high absorbency material is present in the absorbent body 32 in an amount of greater than or equal to about 5 weight percent (wt %), or, more specifically greater than or equal to about 30 wt %, and even more specifically, greater than or equal to about 50 wt % based on a total weight of the absorbent body 32. For example, in a particular aspect, the absorbent body 32 can include a laminate that includes greater than or equal to about 50 wt %, or, more specifically, greater than or equal to about 70 wt % of high-absorbency material overwrapped by a fibrous web or other suitable material for maintaining the high-absorbency material in a localized area.

Optionally, the absorbent body 32 can further include a support (e.g., a substantially hydrophilic tissue or nonwoven wrapsheet (not illustrated)) to help maintain the integrity of the structure of the absorbent body 32. The tissue wrapsheet can be placed about the web/sheet of high-absorbency material and/or fibers, optionally over at least one or both major facing surfaces thereof. The tissue wrapsheet can include an absorbent cellulosic material, such as creped wadding or a high wet-strength tissue. The tissue wrapsheet can optionally be configured to provide a wicking layer that helps to rapidly distribute liquid over the mass of absorbent fibers constituting the absorbent body 32.

Due to the thinness of absorbent body 32 and the high absorbency material within the absorbent body 32, the liquid uptake rates of the absorbent body 32, by itself, can be too low, or cannot be adequately sustained over multiple insults of liquid into the absorbent body 32. To improve the overall liquid uptake and air exchange, the article 20 can further include a porous, liquid-permeable layer of surge management material. The surge management layer is typically less hydrophilic than the absorbent body 32, and can have an operable level of density and basis weight to quickly collect and temporarily hold liquid surges, to transport the liquid from its initial entrance point and to substantially completely release the liquid to other parts of the absorbent body 32. This configuration can help prevent the liquid from pooling and collecting on the portion of the article 20 positioned against the wearer's skin, thereby reducing the feeling of wetness by the wearer. The structure of the surge management layer can also enhance the air exchange within the article 20.

Various woven and nonwoven fabrics can be used to construct the surge management layer. For example, the surge management layer can be a layer including a meltblown or spunbond web of synthetic fibers (such as polyolefin fibers); a bonded-carded-web or an airlaid web including, for example, natural and/or synthetic fibers; hydrophobic material that is optionally treated with a surfactant or otherwise processed to impart a desired level of wettability and hydrophilicity; and the like, as well as combinations including at least one of the foregoing. The bonded-carded-web can, for example, be a thermally bonded web that is bonded using low melt binder fibers, powder, and/or adhesive. The layer can optionally include a mixture of different fibers. For example, the surge management layer can include a hydrophobic, nonwoven material having a basis weight of about 30 to about 120 g/m².

The illustrated article 20 has front and back side panels 34, 134 defining transversely opposite sides of the article 20 in the wear configuration of the article 20. The side panels 34, 134 can be permanently attached in the respective front and back waist regions 22 and 24. The side panels 34, 134 can be attached using attachment means known to those skilled in the art such as adhesive, thermal, pressure or ultrasonic bonding. Alternatively, the side panels 34, 134 can be formed as an integral portion of a component of the absorbent assembly.

The side panels 34, 134 suitably, although not necessarily, include a stretchable material capable of stretching in a direction generally parallel to the transverse axis of the article 20. More suitably the side panels 34, 134 include an elastic material. Suitable elastic materials, as well as one process of incorporating stretchable side panels into training pants, are described in the following U.S. Pat. No. 4,940,464 issued Jul. 10, 1990 to Van Gompel et al.; U.S. Pat. No. 5,224,405 issued Jul. 6, 1993 to Pohjola; U.S. Pat. No. 5,104,116 issued Apr. 14, 1992 to Pohjola; and U.S. Pat. No. 5,046,272 issued Sep. 10, 1991 to Vogt et al.; all of which are incorporated herein by reference. In particular aspects, the stretch material can include a stretch-thermal laminate (STL), a neck-bonded laminate (NBL), a reversibly necked laminate, or a stretch-bonded laminate (SBL) material. Methods of making such materials are well known to those skilled in the art and described in U.S. Pat. No. 4,663,220 issued May 5, 1987 to Wisneski et al.; U.S. Pat. No. 5,226,992 issued Jul. 13, 1993 to Morman; European Patent Application No. EP 0 217 032 published on Apr. 8, 1987 in the name of Taylor et al.; and PCT application WO 01/88245 in the name of Welch et al.; all of which are incorporated herein by reference.

The article fastening system 80 includes laterally opposite first article fastening components 82 adapted for refastenable engagement to corresponding second article fastening components 84. In one aspect, a front or outer surface of each of the article fastening components 82, 84 includes a plurality of engaging elements. The engaging elements of the first article fastening components 82 are adapted to repeatedly engage and disengage corresponding engaging elements of the second article fastening components 84 to releasably secure the pants 20 in its three-dimensional configuration. The article fastening system 80 provides an attachment of a strength sufficient to maintain the article in a wear configuration during use of the article 20 by the wearer.

The article fastening components 82, 84 can include any refastenable fasteners suitable for absorbent articles, such as adhesive fasteners, cohesive fasteners, mechanical fasteners, or the like. In particular aspects, the article fastening components 82, 84 include mechanical fastening components for improved performance. Suitable mechanical fastening components can be provided by interlocking geometric shaped materials, such as hooks, loops, bulbs, mushrooms, arrowheads, balls on stems, male and female mating components, buckles, snaps, or the like.

In the illustrated aspect, the first article fastening components 82 (i.e., one on each side of the article 20) include loop fasteners and the second article fastening components 84 include complementary hook fasteners. Alternatively, the first article fastening components 82 can include hook fasteners and the second article fastening components 84 can include complementary loop fasteners. In another aspect, the article fastening components 82, 84 can include interlocking similar surface fasteners, or adhesive and cohesive fastening elements such as an adhesive fastener and an adhesive-receptive landing zone or material; or the like. Although the article 20 illustrated in FIG. 1 shows the back side panels 134 overlapping the front side panels 34 upon connection thereto, which is convenient, the article 20 can also be configured so that the front side panels 34 overlap the back side panels 134 when connected. One skilled in the art will recognize that the shape, density and polymer composition of the hooks and loops can be selected to obtain the desired level of engagement between the article fastening components 82, 84. A more aggressive hook material can include a material with a greater average hook height and/or a greater percentage of directionally-aligned hooks. When engaged, the article fastening components 82, 84 of the illustrated aspect define the refastenable engagement seams.

The absorbent article 20 of the present disclosure also includes a sensing/indicating feature or article reactive mechanism 150 that is used to make the user or a caregiver aware of wetness, a medical condition, or another condition associated with or detectable via an article insult. In some aspects of the present disclosure, the article reactive mechanism 150 is a wetness sensor to make the user and/or caregiver aware of an insult to the absorbent article 20. The wetness sensor/indicator can be a temperature change feature such as those described in U.S. Pat. No. 5,681,298 to Brunner, et al.; a wetness liner such as those described in U.S. Pat. No. 5,658,268 to Johns, et al.; a cotton liner, an expanding feature such as those described in U.S. Patent Application Publication No. 2004/0254549 to Olson, et al.; an effervescent or foaming feature such as those described in U.S. Pat. No. 6,576,810 to Underhill, et al.; a thermal grill such as those described in U.S. Patent Application Publication No. 2008/0045913 to Johnson, et al.; active graphics that fade, appear, or change such as those described in U.S. Pat. No. 6,297,424 to Olson, et al.; a pH-based feature such as those described in U.S. Patent Application Publication No. 2009/0157025 to Song, et al.; an electronic wetness indicator such as those described in U.S. Pat. No. 7,642,396 to Ales, et al.; and in U.S. Patent Application Publication No. 2010/0164733 to Ales, et al.; any sensor/actuator such as those described in U.S. Pat. No. 6,149,636 to Roe, et al.; or any other suitable wetness sensor/indicator. Each of these patent documents is incorporated by reference herein to the extent it does not conflict herewith. Each of these sensors/indicators produces a result such as a color change, a temperature change, an audible or visible signal, a wireless signal, a change in physical pressure, a tactile change, a vibration, a clammy feeling, or the illusion of heat or discomfort.

In addition, absorbent articles can be used to detect and indicate medical and other conditions such as those described or referenced in U.S. Patent Application Publication No. 2004/0078219 to Kaylor, et al.

Caregivers often have high hopes for training aids, and expect dramatic reactions from their child and from potty training efforts. For example, when using training pants, caregivers have high hopes for toilet training success. Caregivers can become frustrated when their children do not exhibit a dramatic change in behavior (e.g., wetness awareness) or make rapid progress in toilet training (e.g., stops wetting, uses the toilet). As a further complication, a caregiver has much higher expectations when using a tactile or cooling awareness product than with standard training pants. With training pants that provide cooling when insulted, caregivers expect that the child will “be uncomfortable,” “be upset at feeling wet,” and will “recognize consequences.” The cooling is anticipated to be dramatic—enough to wake a sleeping child, enough to interrupt a playing child, enough to motivate a child to avoid wetting.

Studies have shown that caregivers do not introduce sensing/indicating products to their children or other subjects, and most children and other subjects are not certain what to expect or how to react when they insult the product. Caregivers believe the child is too young to understand the concept, yet somehow expect a dramatic negative experience to make the connection and alter behavior. Fewer than half tell their children that the cool feeling occurs after wetting or demonstrate the pant becoming cool. This lack of clear association of coolness and wetness by the child highlights the need for an educational demonstration.

The present disclosure is generally directed to educational tools for use in conjunction with disposable absorbent articles, particularly those that can help to educate a caregiver and a user/subject with respect to the sensor/indicator such an absorbent article might contain. To enhance the training experience, caregivers are encouraged to introduce the sensor/indicator product to their children, to themselves, or to other subjects by demonstrating the sensor/indicator article including a demonstration of the expected result. A simulation tool and instructions can be included with a package of training pants so caregivers and children or other subjects can see and feel how the product works.

An easy-to-use simulation tool and package inserts offering suggestions for introduction can help to counteract lack of behavior change due to the child or other subject not understanding the meaning of the result. For example, through use of the simulation tool, parents and children can see and feel how a cooling product works. The instructions explain the cooling process (e.g., when, how long, how cold, etc. . . . ) and reassure the caregiver with respect to the safety of the cooling ingredients. The simulation tool allows the caregiver to explain the “mind-body connection” (e.g., it's cold, I wet my pants) and the caregiver's expectations of what the child should do when he or she wets (e.g., tell me and go to the potty).

The simulation tool and instructions can be included in the package, attached to the package, or supplied separately via a shelf display. Although a cooling process training aid is used herein to describe some of the features of the present disclosure, the disclosure is not limited to a cooling demonstration. The present disclosure can be applied to other features and mechanisms as described in more detail below.

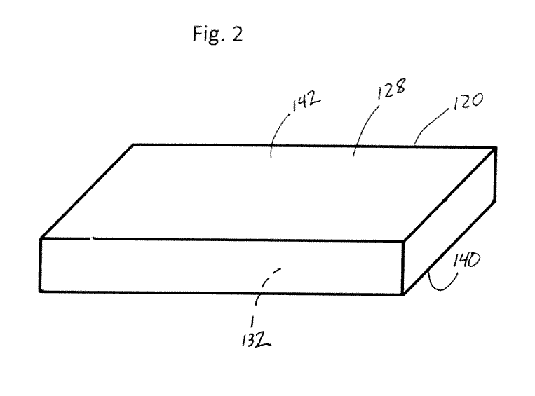

As described above, such a demonstration can be facilitated by providing the caregiver with a simulation tool and appropriate instructions. The simulation tool can be in the form of the simulator 120 of the present disclosure. Referring to FIG. 2, in one aspect, the simulator 120 is a disposable article optionally including a generally liquid impermeable backsheet 140 and a liquid permeable topsheet 142 positioned in facing relation with the backsheet 140. The simulator 120 includes an absorbent body 132, such as an absorbent pad, that is located between the topsheet 142 and the backsheet 140 if present. The simulator 120 has an upper surface 128. The simulator 120 is generally a simple version of the absorbent article 20.

The simulator 120 is intended to demonstrate the liquid-handling and sensing and indicating functionalities of the absorbent article 20, and therefore does not necessarily need the elastics, flaps, cuffs, tabs, wings, peel strips, side panels, surge materials, spacers, fasteners, strings, applicators, non-active graphics, waist features, and other structures and features of a standard absorbent article 20. These structures and features can be present in the simulator 120, but they are not typically required for the simulator 120 to function. In other aspects, the simulator 120 can include one or more of these structures and features if desired for context or realism in the simulator 120. The simulator 120 is generally a sample of absorbent material that is covered, sealed, enclosed, or otherwise processed to be a self-contained structure that inhibits the loss of absorbent material from the simulator 120.

In alternative aspects of the present disclosure, the simulator 120 can simply be a substrate such as a nonwoven, tissue, plastic, card stock, corrugate, or any other suitable material sufficient to provide the functionality described below.

The simulator 120 also includes whatever structures and features are necessary to simulate the sensing and/or indication functions of an absorbent article 20 with which the simulator 120 is associated, as is described in more detail below. The simulator 120 can work in a number of different ways depending on the mechanism used by the article reactive mechanism 150 in the associated absorbent article 20.

In one aspect of the present disclosure, the simulator 120 is configured with a simulator reactive mechanism that is the same mechanism as that of the article reactive mechanism 150 in the absorbent article 20. For example, if the absorbent article 20 includes an article reactive mechanism 150 that indicates wetness in the absorbent article 20 by producing the result of cooling via the inclusion in the absorbent article 20 of a cooling substance such as sorbitol, then the simulator can also include sorbitol. The addition of water to the simulator 120 will thereby produce the same cooling result as an insult produces in the absorbent article 20. It should be noted that, in each of the aspects described herein, the simulation produced by the simulator 120 need not exactly replicate the result produced in the article 20. In one aspect, the result is a cooling effect. The simulator 120 will produce a cooling effect as well, but need not produce a cooling effect that is equivalent in the extent of temperature change or in the amount of heat flux produced. This discussion of a cooling effect is provided for exemplary purposes; the same prospect applies to other results/sensors/indicators as well. The simulator 120 need not produce a simulation that is identical to the result from the article reactive mechanism 150. The simulation should replicate the manner of the result but not necessarily the magnitude, extent, absolute value, etc.

Article reactive mechanisms 150 that can be demonstrated in this manner include many of those described above including temperature change mechanisms including cooling mechanisms, wetness liners, cotton liners, pressure/expansion mechanisms, foaming mechanisms, thermal grills, active graphics including fading, appearing, and changing graphics, electronic wetness indicators, and many of the sensors/actuators described in U.S. Pat. No. 6,149,636 to Roe, et al.

Various other article reactive mechanisms 150 are not readily simulated using plain water, even with the same mechanism in the simulator 120. Article reactive mechanisms 150 that sense and indicate pH, biological analytes, and the like typically include at least one additional element in or associated with the simulator 120 to produce the desired result.

To address this, and in another aspect of the present disclosure, the simulator 120 is again configured with a simulator reactive mechanism that is the same mechanism as that of the article reactive mechanism 150 in the absorbent article 20. For example, if the absorbent article 20 includes an article reactive mechanism 150 that indicates wetness in the absorbent article 20 by producing the result of a color change via the inclusion in the absorbent article 20 of a pH-sensitive adhesive, then the simulator can also include the pH-sensitive adhesive. Unlike the previous aspect, however, the addition of water to the simulator 120 will not produce the same color change because water has a higher pH than urine. This discrepancy can be addressed by also adding a substance such as crystalline citric acid to the simulator 120. The addition of water to the simulator 120 will thereby dissolve the citric acid, thus decreasing the pH of the added water enough to produce the same color change result as an insult produces in the absorbent article 20.

In still another aspect of the present disclosure, the simulator 120 is again configured with a simulator reactive mechanism that is the same mechanism as that of the article reactive mechanism 150 in the absorbent article 20. For example, if the absorbent article 20 includes an article reactive mechanism 150 that indicates wetness in the absorbent article 20 by producing the result of a color change via the inclusion in the absorbent article 20 of a pH-sensitive adhesive, then the simulator 120 can also include the pH-sensitive adhesive. Unlike the previous aspect, however, the addition of water to the simulator 120 will not produce the same color change because water has a higher pH than urine. This discrepancy can be addressed by providing with the simulator 120 a sample of a liquid that will produce the same result in the simulator 120. For example, the simulator 120 can be provided with a sample of dilute acetic acid that, when added to the simulator, will produce the same color change result as an insult produces in the absorbent article 20. The sample can include a liquid that will have the same or similar effect as an insult, or the sample can include the same substance that produces the result, or both. The former case is generally preferred in that, for example, a vial of diluted acetic acid that will cause a pH indicator to change color is preferable to providing and working with synthetic or real urine.

In yet another aspect of the present disclosure, the simulator 120 is configured with a simulator reactive mechanism that is different from the article reactive mechanism 150 in the absorbent article 20. For example, if the absorbent article 20 includes an article reactive mechanism 150 that indicates wetness in the absorbent article 20 by producing the result of a color change via the inclusion in the absorbent article 20 of a pH-sensitive adhesive, then the simulator can include a wetness-indicating ink that produces the same color change result when wetted with water. As a result, the addition of water to the simulator 120 will produce the same color change result as an insult produces in the absorbent article 20.

In use, the simulator 120 is useful in educating a caregiver and a child or other subject with respect to what result to expect upon the insult of an absorbent article 20.

To enhance this approach, the disposable absorbent article system can also include instructions or an informational item 160 meant to instruct a caregiver with respect to the approaches and benefits described above. The instructions 160 offer suggestions for introduction and can help to counteract lack of behavior change due to the child or other subject not understanding the meaning of the result. For example, through use of the simulation tool, parents and children can see and feel how a cooling product works. The instructions 160 explain the cooling process (e.g., when, how long, how cold, etc. . . . ) and reassure the caregiver with respect to the safety of the cooling ingredients. The simulation tool allows the caregiver to explain the “mind-body connection” (e.g., it's cold, I wet my pants) and the caregiver's expectations of what the child should do when he or she wets (e.g., tell me and go to the potty). The simulation tool and instructions 160 can be included in the package, attached to the package, or supplied separately via a shelf display.

Examples of informational items 160 include cards, paper, electronic media, printing on the packaging, or other suitable media capable of storing and conveying information. In other aspects of the present disclosure, the informational item 160 can be the same object as the simulator 120. For example, necessary instructions for use, and expected results, can be included on the substrate that forms the simulator 120.

The informational item 160 can also include information with respect to other tips and approaches to successful toilet training, including information regarding an appropriate response to an insult incident. Appropriate responses to an insult incident can include discussing physical sensations with the subject; informing the subject with respect to the relation between the physical sensations and the imminence of the insult; taking the subject to a bathroom; positioning the subject on a toilet; encouraging the subject to produce an insult; recognizing positive actions by the subject; and recognizing toilet training progress by the subject.

The informational item 160 can also include information regarding tracking and assessing toilet training progress. In other aspects of the present disclosure, the informational item 160 can include a growth chart, sizing information for shoes, sizing information for clothes, sizing information for absorbent articles, and/or other information useful to a caregiver or a child, printed or otherwise disposed thereon.

The informational item 160 can also include information or instructions about children's health and hygiene, such as sleep habits, thumb sucking, teething, skin health, toilet training; questions to ask a child; jokes; and the like, and combinations thereof. The informational item 160 can additionally or alternatively include addresses for web sites available on the internet. The web sites can contain information related to issues of interest for caregivers and users of the absorbent article system.

The following non-limiting examples illustrate various aspects of the present disclosure, as described in more detail above.

In one example, the simulator 120 includes a visual wetness indication and instructions related to expectations and optionally responses. A caregiver reads the instructions to understand what is going to change and what is going to trigger the change. Based on these inputs, the caregiver uses the simulator 120 that simply includes a wetness indicating adhesive or ink, thus removing complexity and cost because the simulator 120 has no absorbent, outer cover, etc.

In another example, the simulator 120 also includes a visual wetness indication and instructions related to expectations and optionally responses. The simulator 120 in this example is more “real” to calibrate the caregiver's expectations. The simulator includes a reverse-printed wetness indicator on a piece of outer cover material with a facing that is disposed on a contrasting background color, such as a white card. By placing the indicator on the outer cover material, the caregiver is better calibrated to the visual change due to the opacity of the outer cover and reduced brilliance of the colors.

In still another example, the simulator 120 includes a fullness indicator having visual and/or electronic feedback. The caregiver reads the instructions for understanding and then can wet the card to see the change. The card can include information and guidance to redirect the caregiver to more information on the internet. The caregiver can scan the simulator 120 or the instructions with a telephone or other imaging device and use an application or website to read the image and give her instructions and feedback on what the feedback means and how to interpret the results. The information provided can also introduce how things can vary and thereby set expectations appropriately.

In yet another example, the simulator 120 can include wetness detection with audible feedback. The caregiver interacts with an electronic signaling device that can be set in a demonstration mode, where the instructions give simple information with respect to what the device will demonstrate. The demonstration information can be included in the instructions for the signaling device. For example, the caregiver holds a button on the signaling device, causing several tones or other sounds to play over time. The instructions can list the tones and sounds and how to identify each and when each is expected during use.

In another example, the simulator 120 can include wetness detection with audible feedback. The caregiver interacts solely with the instructions to get all information needed to calibrate expectations during use of the simulator 120. This can be achieved by having the instructions provide a scannable code (scannable by telephone, computer, etc.) that redirects the caregiver to a training video. The training video can walk through operation and set expectations during use. Along the way, the video can ask for feedback via quizzes/games that the caregiver and/or subject can participate in to further increase their interaction during use of the simulator 120.

In a further example, the simulator 120 can include a tactile wetness indicator providing coolness feedback. The caregiver and a child or other subject can feel the cooling sensation and calibrate their interaction with the simulator 120 with expectations of the product. In this example with reduced cost and complexity, cooling sugars are suspended in an adhesive and applied to the simulator 120. When the simulator 120 is wetted, the cooling sensation can be felt on the simulator 120.

In each of the aspects described herein, the experience can be tailored to how people learn. For example, coolness via tactile is a hands-on experience. Visual indicators can use recognition of other colors to help with differentiation and reinforce the expected result, such as through games or quizzes. Audible indicators can use a combination of hands-on experience and recognition. One hears tones, receives instructions with respect to what the tones mean. After several tones and instruction, a game or quiz can be used to reinforce the learning.

In addition to the aspects described herein, the simulators 120 can be differentiated by pant size and relative age or gender. For example, as a child gets older, the levels of interaction, complexity, and feedback of the simulators 120 can be altered to better align the simulator 120 to how people learn. New caregivers might prefer simpler systems so the more instruction and calibration they are given can result in better recognition in the future. Children at a younger age might respond less to tactile indications and less to colors, visual indications, or sounds. The caregiver and/or subject can start with simpler systems and then build expectations and grow complexity as age and cognitive ability starts to grow. The aspects describe herein enable a customized experience to accommodate the understanding that every child potty trains differently.

These and other modifications and variations to the present invention may be practiced by those of ordinary skill in the art, without departing from the spirit and scope of the present invention, which is more particularly set forth in the appended claims. In addition, it should be understood that aspects of the various aspects of the present invention may be interchanged either in whole or in part. Furthermore, those of ordinary skill in the art will appreciate that the foregoing description is by way of example only, and is not intended to limit the invention so further described in such appended claims.

What is claimed:

1. A disposable absorbent article system comprising:
a disposable absorbent article having a liquid-permeable layer, an article absorbent core, and an article reactive mechanism configured to produce a result upon exposure to an insult; and
an article simulator having a substrate and a simulator reactive mechanism configured to produce the result upon exposure to a simulant, the article simulator having fewer components than the absorbent article.

2. The system of claim 1, wherein the simulant is water.

3. The system of claim 1, wherein the article reactive mechanism includes a wetness indicator, and wherein the result is a visual indication.

4. The system of claim 1, wherein the article reactive mechanism includes an active graphic, and wherein the result is a changed graphic.

5. The system of claim 1, wherein the article reactive mechanism includes a temperature change element, and wherein the result is a temperature change.

6. The system of claim 1, wherein the article reactive mechanism is a pH indicator, and wherein the article simulator includes a pH-altering substance.

7. The system of claim 1, wherein the article reactive mechanism is configured to detect a biological analyte.

8. The system of claim 1, wherein the article reactive mechanism and the simulator reactive mechanism are the same mechanism.

9. The system of claim 8, wherein the article reactive mechanism is an electronic signaling device usable with the article and with the article simulator.

10. The system of claim 1, wherein the article includes a liquid-impermeable outer cover and the article simulator includes a liquid-impermeable outer cover and a simulator absorbent core.

11. A method for facilitating training comprising:
providing a disposable absorbent article having an article reactive mechanism configured to produce a result upon exposure to an insult;
providing an article simulator having a substrate and a simulator reactive mechanism configured to produce the result upon exposure to a simulant; and
instructing a consumer to use the simulator to produce the result.

12. The method of claim 11, further comprising providing the simulant with the article simulator.

13. The method of claim 11, wherein the article reactive mechanism includes a wetness indicator, and wherein the result is a visual indication.

14. The method of claim 11, wherein the article reactive mechanism includes an active graphic, and wherein the result is a changed graphic.

15. The method of claim 11, wherein the article reactive mechanism includes a temperature change element, and wherein the result is a temperature change.

16. The method of claim 11, wherein the article reactive mechanism is a pH indicator, and wherein the article simulator includes a pH-altering substance.

17. The method of claim 11, wherein the article reactive mechanism is configured to detect a biological analyte.

18. The method of claim 11, wherein the article reactive mechanism and the simulator reactive mechanism are the same mechanism.

19. The method of claim 18, wherein the article reactive mechanism is an electronic signaling device usable with the article and with the simulator.

20. A method for facilitating training comprising providing an article simulator having a substrate and a simulator reactive mechanism configured to produce a simulator result upon exposure to a simulant, wherein the simulator result simulates an article result obtained from an insult to a disposable absorbent article having an article reactive mechanism, wherein the article simulator has fewer components than the absorbent article, and wherein the simulator result is substantially identical to the article result.
